(19) United States
(12) Patent Application Publication
(10) Pub. No.: US 2008/0002654 A1
(43) Pub. Date: Jan. 3, 2008

(54) Authorisation in Cellular Communications System

(75) Inventor: Johan Bolin, Uppsala (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/721,852

(22) PCT Filed: Nov. 18, 2005
(86) PCT No.: PCT/SE05/01736

§ 371 Date: Jun. 15, 2007

(30) Foreign Application Priority Data
Dec. 17, 2004 (SE) 0403114-2

(51) Int. Cl. H04H 1/00; H04L 29/06

(52) U.S. Cl. 370/339; 455/414.3

(57) ABSTRACT

Methods and devices for encoding and decoding secure data entities are presented, which use at least parts of broadcast control messages (13) used by a cellular communications system (18) to which an intended user (10) is connected for obtaining suitable keys. Since the broadcast control messages (13) are sent continuously, the invention works without additional signaling when the application or content is actually used. The broadcast control messages (13) can also be different from time to time and/or from cell to cell, which opens up for usage restrictions both in space and in time. The present invention can also be operable on secure data entities provided in any transmission format supported by the user device (10), not only for secure data entities provided through the cellular communications system (18) itself.

### TECHNICAL FIELD

The present invention relates in general to digital rights management, and in particular to digital rights management for data content and applications in devices connected to cellular networks.

### BACKGROUND

Software applications and data files representing video signals or sound tracks are today often transmitted between a service provider and an end user. Since many of these applications and data files are associated with an authorization to use the application or file, e.g. connected to payments, there are many different kinds of digital rights management systems available. Digital rights management solutions are being standardized (e.g. in OMA) and several are already used in media formats such as video and music. The present development in mobile phones tends to incorporate more and more alternative communication systems, such as Internet connections, IR or Bluetooth connections, receivers of radio and/or TV signals etc. Digital rights management is therefore also introduced in mobile phones, controlling how applications and media files can be used in mobile phones.

Prior art solutions of digital rights management are typically based on encryption and decryption of the digital entity in question, using a key that is known exclusively by the authorized parties. Such keys can be distributed in many different ways, e.g. by ordinary mail, secure e-mail or other secure signalling. The keys are typically changed intermittently, either to provide a tool to restrict the authorization in time or to prevent unauthorized parties to break the codes.

In non-cellular communications systems, such as wired and/or wide or local network communications systems, the users and the connection configuration are typically known, at least by a server controlling the system or part thereof. In a typical case, members may join and leave a group of identified users, i.e. users connect to different sessions. The connection to a session is typically performed by sending control messages between the server and the user equipment. The users may then have their individual keys already upon connection, or they may be provided by an individual key during that session.

One example of such a keys distribution in a wide area network system is disclosed in U.S. Pat. No. 6,684,331, where efficient distribution of group session keys and private keys is achieved by means of a tree structure. This solution, and similar solutions referred to therein, are session based and are dependent on that an actual tree structure is both present and known. Such solutions are therefore obviously not applicable in cellular communications systems.

### SUMMARY

A general problem with prior art digital rights management for devices connected to cellular communications networks is that key handling is slow and/or requires extensive signalling. A subsidiary problem is that downloading of applications and/or media files occupies relatively large resources in a cellular communications system.

An object of the present invention is to provide improved methods and devices for handling of secure data entities for use in devices connected to a cellular communications system. A further object of the present invention is to reduce the amount of signalling required for key handling and/or downloading of secure data entities.

The above objects are achieved by methods and devices according to the enclosed claims. In general words, at least parts of broadcast control messages used by a cellular communications system to which an intended user is connected are used for obtaining keys for encoding and decoding secure data entities. Since the broadcast control messages are sent continuously, the invention works without additional signalling when the application or content is actually used. The broadcast control messages can also be different from time to time and/or from cell to cell, which opens up for usage restrictions both in space and in time. The present invention can also be operable on secure data entities provided in any transmission format supported by the user device, not only for secure data entities provided through the cellular communications system itself. The present invention is also possible to implement on systems, where the actual decoding is performed in a unit, separate from but connected to the cellular network user device.

One main advantage with the present invention is that no additional user specific signalling is necessary at the occasion for accessing the secure data entity. Moreover, the authorization for access to the secure data entity can be time and/or position dependent. Furthermore, since the method can be made operable on data entities transferred to the user device, or any device in connection therewith, using any communication technology, download utilization of radio resources in the cellular communications network may be avoided.

### BRIEF DESCRIPTION OF THE DRAWINGS

The invention, together with further objects and advantages thereof, may best be understood by making reference to the following description taken together with the accompanying drawings, in which:

FIG. 1 is an illustration of a block scheme of a cellular communications system according to prior art, providing data entities from a service provider;

FIG. 2 is an illustration of a block scheme of an embodiment of a cellular communications system according to the present invention;

FIG. 3 is an illustration of signalling according to an embodiment of the present invention during download and use of a secure data entity;

FIG. 4 is an illustration of a block scheme of another embodiment of a cellular communications system according to the present invention;

FIG. 5A is an illustration of a block scheme of yet an embodiment of a cellular communications system according to the present invention;

FIG. 5B is an illustration of a block scheme of yet another embodiment of a cellular communications system according to the present invention;

FIG. 6 is an illustration of a block scheme of yet another embodiment of a cellular communications system according to the present invention;

FIG. 7A is a block scheme illustrating an embodiment of encoding data files according to the present invention;

FIG. 7B is an illustration of a block diagram of an embodiment of a device providing secure data entities according to the present invention;

FIG. 8A is a block scheme illustrating an embodiment of decoding data files according to the present invention;

FIG. 8B is an illustration of a block diagram of an embodiment of a device receiving and decoding secure data entities according to the present invention;

FIGS. 9A-D are schematic illustrations of embodiments of hierarchical content structures in broadcast control signals that can be used in the present invention;

FIG. 10 is a flow diagram of the main steps of an embodiment of a method for providing secure data according to the present invention;

FIG. 11 is a flow diagram of the main steps of an embodiment of a method for accessing secure data according to the present invention; and

FIG. 12 is a flow diagram of the main steps of an embodiment of a method for distributing secure data according to the present invention.

### DETAILED DESCRIPTION

In the present disclosure, “Mobile Station” (MS), “Mobile Phone”, “Mobile Terminal” and “Handset” all refers to the device connected to the cellular communications system. This device is typically a mobile telephone, hand held computer (PDA) or other device/apparatus equipped with a radio receiver for cellular/mobile network.

The term “position” means in the present disclosure a geographical position given as coordinates or degrees (e.g. the WGS-84 datum). It may also contain orientation and/or heading, speed, acceleration etc. A position may also be given as a relative measure.

The term “location” is a more subjective position defined by the type of (or relation to) facility or place. Examples of locations are: “military area/facility”, “hospital”, “office”, “theatre”, “near emergency exit”.

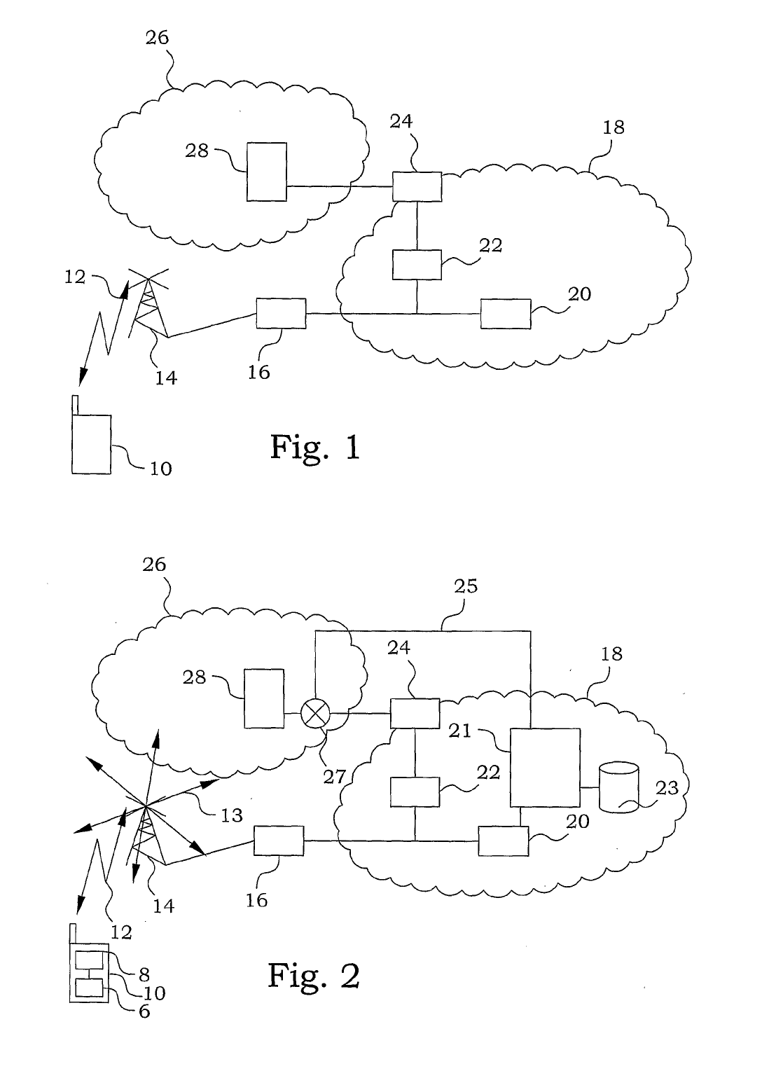

FIG. 1 illustrates a prior art system for providing secure data entities. A mobile terminal 10 is connected by a radio connection 12 to an antenna 14 of a base station 16. The base station 16 is connected to a core network 18 of a cellular communications system and is controlled by a base station controller 20. A packet data node, e.g. a Serving General Packet Radio System (GPRS) Support Node (SGSN) 22 is provided to control data traffic in the communications system. A gateway node, e.g. a Gateway GPRS Support Node (GPRS) 24 serves as a gateway to e.g. an Internet network 26. A service provider 28 at the Internet 26 produces data entities, i.e. software applications and/or data files such as different media files, that can be communicated through the cellular communications network to the mobile terminal 10. Extensive signalling of authorization messages and data is performed in connection to the download of the data entity. The provision of the data entities does not only occupy resources during the actual download procedure, but causes also additional signalling when handling codes, keys etc.

In cellular communications systems, the conditions are completely different compared with wired systems or systems having a defined network structure. A configuration of a network as e.g. a tree structure is impossible to achieve in cellular communications systems, since communications in a cellular structure is based on communication between a number of user equipments and a central base station. Furthermore, since the transmissions are made in a publicly available medium, the radio ether, the signals may be available for users that are unknown by the base station. In other words, “broadcasting” of signals in a wired system has completely different characteristics than broadcasting of signals in a wireless system. In a wired system or defined network based system, even a “broadcast” signal is known to reach only a limited number of identified users, whereas in a wireless system a broadcast signal can be received by virtually any user within signal range. This difference in broadcast properties has advantages as well as disadvantages. A main disadvantage of cellular broadcasting is that also unauthorized users may detect the signal. In order to restrain unauthorized use, the content has to be arranged in such a way that it is unusable for any unauthorized party. A main advantage of cellular broadcasting is instead that there is a possibility to distribute information to a user without the need for the user to be actually actively connected in a running session with the communications system, but can instead just be passively residing in the cell area of a base station.

In the present invention, an important part is that a broadcasted control message in a cellular system is used as a lock or for authorization control purposes when distributing application or media files to a mobile phone user. By “blending” a SMSCB message (in GSM embodiments), or a function of the message, with the content file sent to the mobile phone, the SMSCB message received by the phone can be used as a key to unlock the content. The content can also be built in such way that it differs depending on the current SMSCB message. This means that it is possible to create e.g. coupons where the coupon is unique for the user, the time it is used and/or the location. All this is possible to achieve without having to make any dedicated signalling when the data content or application is opened or executed.

In FIG. 2, an embodiment of a cellular communications system according to the present invention is illustrated as a block scheme. Corresponding parts as in FIG. 1 are denoted by the same reference numbers and are not further discussed. The core network 18 comprises a broadcast message control node 21 connected to the base station controller 20. The broadcast message control node 21 is responsible for the messages that are broadcast in the different cells associated with the core network 18. The content of the broadcast message is obviously independent of which mobile terminals are present in the different cells. The broadcast message control node 21 has typically access to a database 23, in which useful messages are stored for easy retrieval. They can be changed according to patterns or cycled. Preferably, also future planned broadcast messages are stored together with intended time intervals during which they are going to be used, and identifications of cells, in which they are intended to be used. Although illustrated as separate units in FIG. 2, the broadcast message control node 21 and the database 23 are typically integrated in one physical node. The broadcast message control node 21 instructs the base station controller 20 to perform the actual broadcast. The broadcast message is illustrated as signal arrows 13 not dedicated for any particular mobile station 10. The mobile station 10 comprises in a control plane a broadcast message receiver 6 that detects the message and may take appropriate actions depending on the content.

A service provider 28 at the Internet 26 produces data entities, which are intended for the user 10, to be opened or used under certain agreements. An encoding unit 27 has a connection 25 to the broadcast message control node 21 in the core network 18, and is provided with information about which broadcast messages that are going to be used when and where. Depending on the agreement between the service provider 28 and the user 10, a broadcast message is selected and at least a part of this message is used as a part of the encoding procedure, to produce a secure data entity that can not be freely accessed, i.e. at least not opened, executed or properly decoded. The encoders thereby “blends” the original content with a function of the broadcast message. The encoded data entity is communicated to the intended end user 10, in this embodiment by using the ordinary data transferring capacities in the communications system. The last part of this transfer takes e.g. place over a dedicated downlink user data signalling 12 from the base station antenna 14 to the user terminal 10. The encoded data entity is received in an application 8 in a user plane of the mobile terminal 10.

In order to be entitled to access the real content of the data entity, the encoded data entity has to be decoded. The decoding is at least partially based on a data representing the broadcast message, provided by the broadcast message receiver 6 in the mobile terminal 10 control plane. In this way, the content can not be accessed, i.e. not opened, executed or properly decoded, unless the mobile terminal 10 receives a broadcast messages that is compatible with the data entity coding. If the data entity is a link in e.g. a browser, the actual access for the associated data file is prohibited, unless the broadcast message is compatible. Since the broadcast messages can be changed with time and/or cell, the access to the data entity can be controlled in the same aspects.

The broadcast control message is thus used to provide an authorization key for the secure data entity. Such an authorization key may also be based on an identity associated with the user terminal. In such a way, the use is restricted to a particular user.

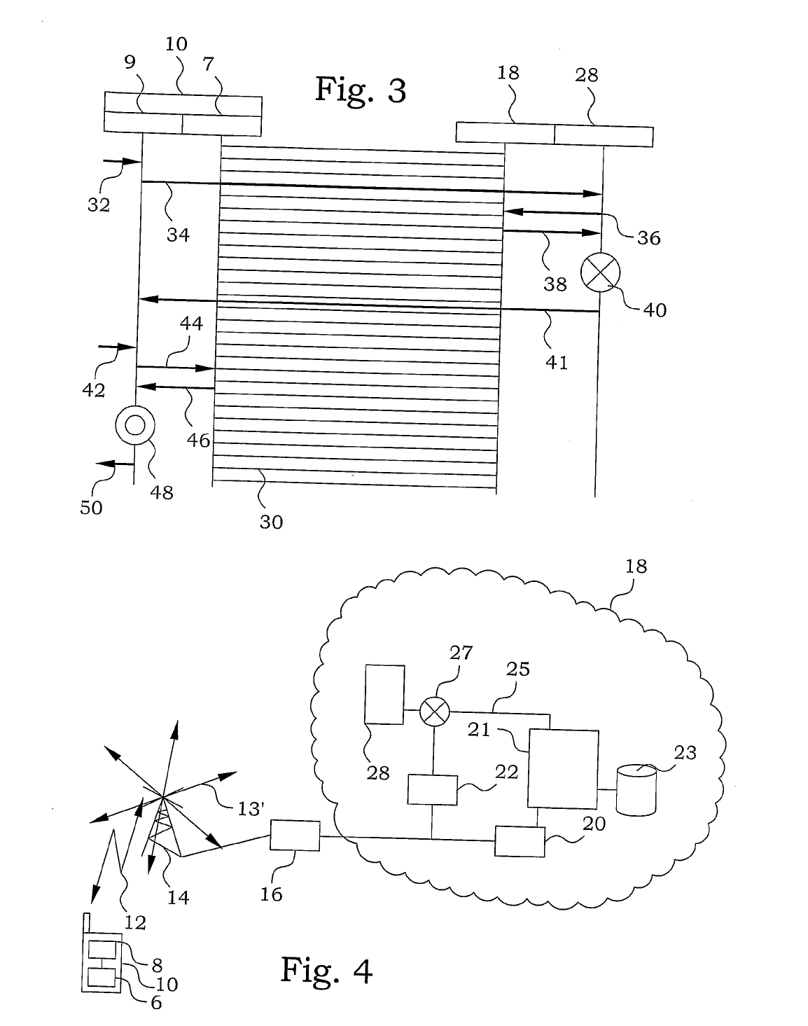

A typical signalling sequence is shown in FIG. 3. A time dimension is intended to be directed downwards in the figure. At the left side, the user terminal 10 is illustrated, with its control plane 7 and its user plane 9. At the left side, the cellular network 18 and the service provider 28 are illustrated. The narrow lines 30 is intended to visualize the continuous broadcast of messages from the cellular network 18 to the control plane 7 of the user terminal 10. In GSM, this is performed via broadcast channel SMSCB in the control plane.

At a certain occasion 32, a user decides to request an access to an data entity from the service provider 28. A request message 34 is sent from the user plane 9 of the mobile terminal 10 to the service provider. The black arrow represents signalling on a user channel, e.g. GPRS, WAP or a UMTS data transport channel. The service provider 28 receives the request and determines an intended validity, in time and space, of access to the requested data entity. In this embodiment, a request 36 for information about future broadcast messages is sent from the service provider 28 to the cellular network 18. The cellular network 18 responds with information 38 about broadcast control messages that will appear at the requested times and locations. The service provider 28 uses this information and encodes 40 the data entity into a coded data entity. This coded data entity is returned 41 to the user terminal 10. The user can now store the received encoded data entity, temporarily or more permanent, or may access it right away. At occasion 42, the user makes an attempt to access the encoded data entity. A request 44 is put from the user plane application supporting the access attempt to the control plane 7 of the user terminal 10. The functionality keeping track of broadcast control messages replies 46 by providing the presently valid broadcast message. The data entity is decoded 48 using at least a part of the broadcast message in the decoding procedure, and at occasion 50, the user may make use of the content of the data entity.

The secure data entity is in one embodiment a data file. This data file may e.g. represent a video sequence, a sound recording, a database etc. The secure digital entity can also be e.g. an application software.

In the embodiment of FIG. 3, the service provider has to send a request for suitable broadcast messages to the cellular network. In alternative embodiments, the information about the broadcast messages can be provided by other means. For instance, if an agreement exists between the cellular network operator and the service provider, the service provider may subscribe on broadcast message information. The information may then be readily available at the occasion the encoding is to take place, and may e.g. be retrieved from a local database.

In FIG. 4, another embodiment of the present invention is illustrated. Here, the cellular network operator provides the service provider 28 and the encoder 27 within the actual communication network 18. In such a case, the information about which broadcast messages that are going to be used can probably be obtained even easier, if it is believed that all nodes within the network have access to all information.

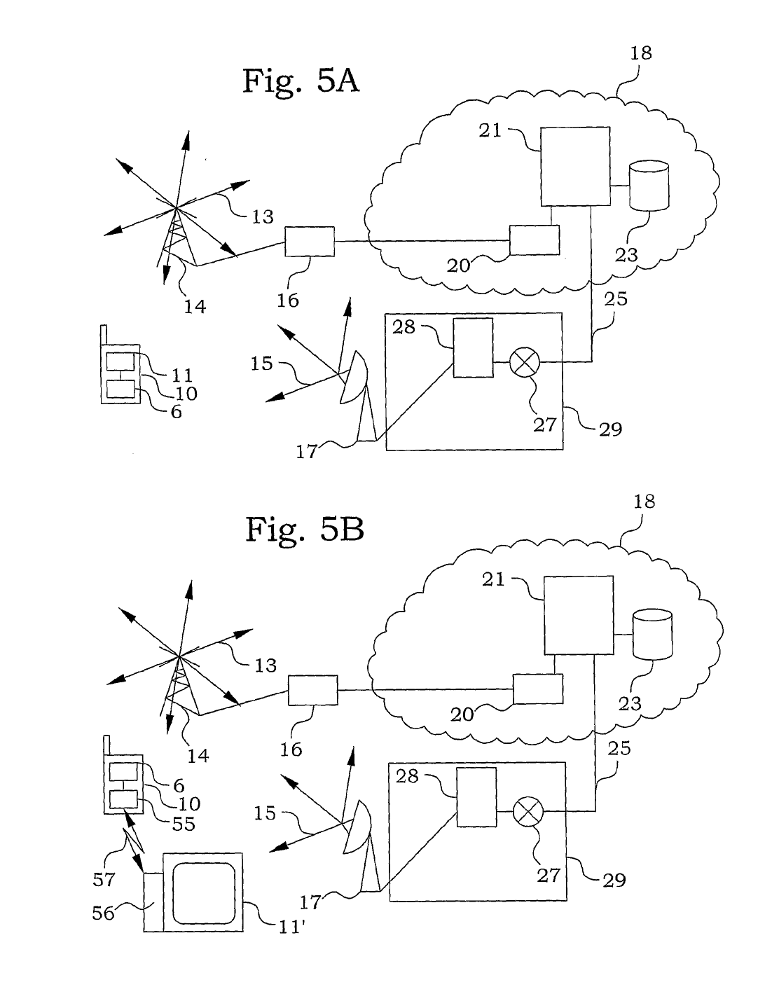

In FIG. 5A, yet another embodiment of a system according to the present invention is illustrated. In this embodiment the service provider 28 is a part of a digital TV (DTV) network 29. The DTV is e.g. intended to be offered to any user of the cellular network within a certain area. This could e.g. be the case in a shopping mall, providing customers with entertainment and advertising during their shopping. Another example could be a sports arena, where replays of important sports situations could be offered free of charge to the spectators via their telephones. However, outside the arena, such video sequences could be provided against a subscription. In this embodiment, there is no initial request for receiving the data entity. Instead the data entity is broadcast to any interested party. The encoding, however, is made according to the above principles and the encoded data entities are spread over at least the intended coverage area by broadcast signals 15 emitted from a DTV antenna 17. A user terminal 10 receives the DTV signals in a DTV receiver 11, and by assistance of the broadcast message received from the cellular network, the DTV data can be properly decoded.

The embodiment of FIG. 5A may also operate with restricted use of the broadcast DTV signals. The service provider could then e.g. send a data file, e.g. through the cellular network, informing the user terminal 10 how to apply the broadcast message in this particular case. Without having such information, it may be impossible to decode the DTV correctly, even if the correct broadcast message is received. Such initial information transfer can then be connected to e.g. a payment of the provided service.

In an alternative embodiment, illustrated in FIG. 5B, a user terminal can be 5 used as a part of a common TV decoder or as an additional functionality connectable to a common TV decoder. A common TV monitor 11′ receives encoded TV signals from the antenna 17. The TV monitor 11′ is further provided with a modified decoder unit 56. A mobile terminal 10 is connected to the decoder unit 56 via cable, fibre or wireless connections, such as WLAN, Bluetooth, IR connections etc. In the present embodiment, a Bluetooth connection 57 is illustrated. The mobile terminal 10 thus has a Bluetooth transceiver unit 55, which is arranged to forward information related to at least relevant parts of a broadcast message received by the receiver 6. The decoder unit 56 receives the information related to the broadcast message and uses this information for decoding the received data entities, in this embodiment TV signals.

In such a way, one may bring the pay-TV subscription by the mobile terminal, without any need for providing any decoder cards or decoder units. As an example, if a subscriber rents a hotel room having a TV set according to the above ideas, the “home” subscription may follow the user. A stream of media channels to the TV set could be coded according to the above principles. A guest may use the mobile terminal to “log on” to the TV set and supply a valid decryption code or suitable parts of the broadcast message.

The actual decoding or authorization can thus be performed in a device, separate from but connected to a mobile terminal 10. The mobile terminal 10 provides in such a case only the necessary broadcast information while the actual decoding is performed elsewhere. Anyone skilled in the art realizes that even if the device 11′ in the embodiment above is a TV set, any device capable of accessing data entities may be used as well, such as different types of media players, computers etc.

The provision of the actual data entity can be performed in any possible manner. The data entity could even be stored in a data memory, e.g. a compact disc or memory card, and be physically transported to the end user, where it is made accessible to the user terminal. The content can still be protected against unauthorized use, since an appropriate broadcast message has to be provided to admit access to the content.

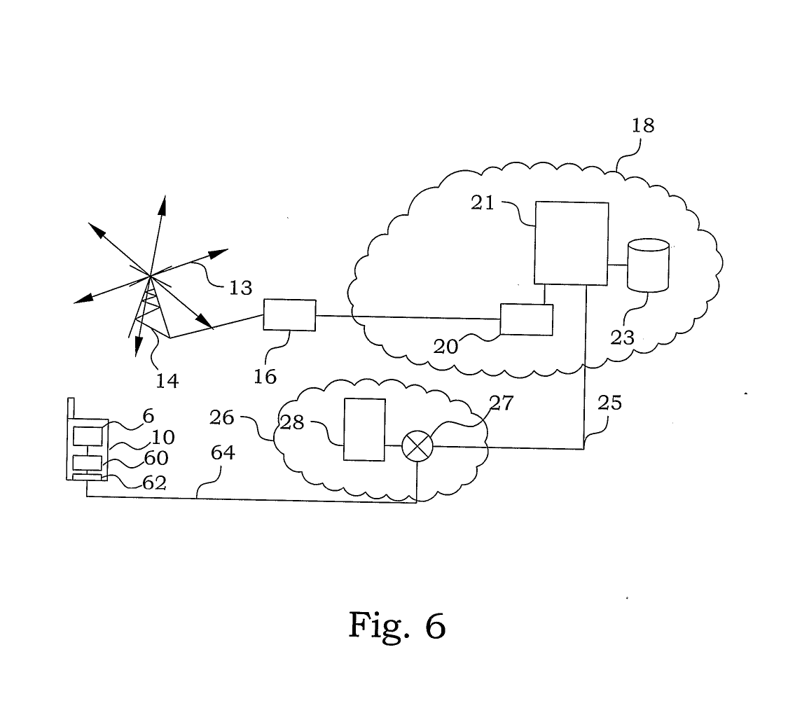

FIG. 6 illustrates an embodiment, where the mobile terminal 10 is equipped with a data communication interface 62 capable of receiving data entities of some data medium 64, e.g. IR communication, Bluetooth techniques, optical fibres or cables. The communication interface 62 is connected to an application 60 arranged for receiving and handling data entities through the communication interface 62. A service provider 28 can thereby provide the actual encoded data entity through a communication channel separated from the cellular network communication. However, the access rights to the data entities are still managed by the cellular communications network through its broadcast messages.

The advantage with such an embodiment, is that if the data entity itself is large, the cellular network does not have to be loaded by transferring the data entity. Instead, more efficient transferring methods can be used. Nevertheless, when accessing the data entity, the access rights are still managed by the cellular network, and does not cause any additional signalling at all, since the broadcast message is a standard part of the control messages, that are always transmitted.

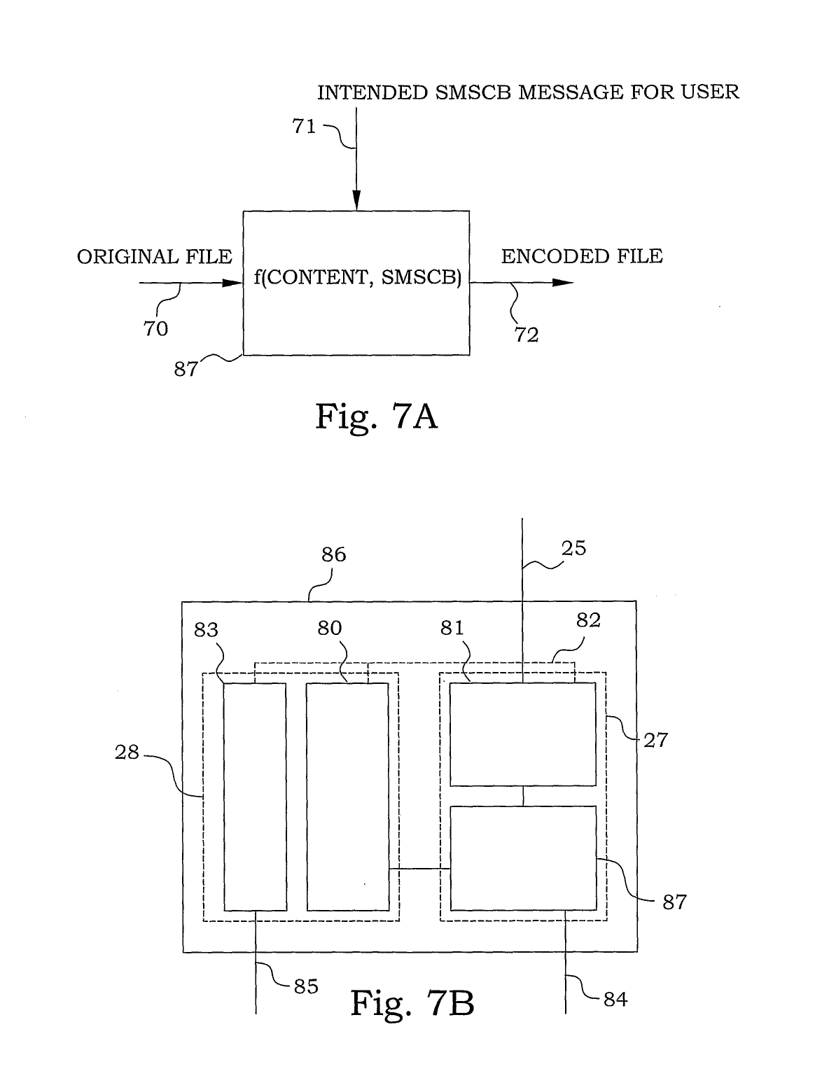

FIG. 7A illustrates an embodiment of the principles for creating the secure data entity according to the present invention. An original file 70 is provided to an encoder 87. Data 71, comprising a symbol sequence, related to at least a part of an intended broadcast message for the intended user is provided to the encoder 87. The encoder 87 is arranged to provide an output encoded data entity 72, being a pre-determined function of the original file content 70 and the symbol sequence 71. The data entity is thus provided with an authorization mechanism. In the embodiment of FIG. 7A, a GSM cellular system is assumed, thereby using the SMSCB messages.

A block scheme of an embodiment of an encoder according to the present invention is illustrated in FIG. 7B. A service provider node 86 comprises a service provider 28 in turn having means 80 for providing an original data entity. The service provider 28 further comprises a control unit 83, which in the present embodiment communicates with external parties by a connection 85. An encoding unit 27 comprises an encoder 87, which performs the actual encoding of the original data entity, and a broadcast control message handling unit 81, which receives data concerning broadcast control messages to use through a connection 25 and creates therefrom a symbol sequence useable for the encoder 87. The encoder 87 creates an authorization mechanism for the original data entity based on the symbol sequence. The secure data entity is presented at an output 84 from the service provider node 86. The control unit 83 is in this embodiment responsible to control the means 80 for providing an original data entity and the broadcast control message handling unit 81, indicated by a dashed line 82. The service provider node 86 may also comprise means for storing the secure data entity at a storage medium, until it is going to be distributed.

The secure data entity is communicated in any manner to the intended user terminal and the user terminal experiences the broadcast control messages from its cellular communications network.

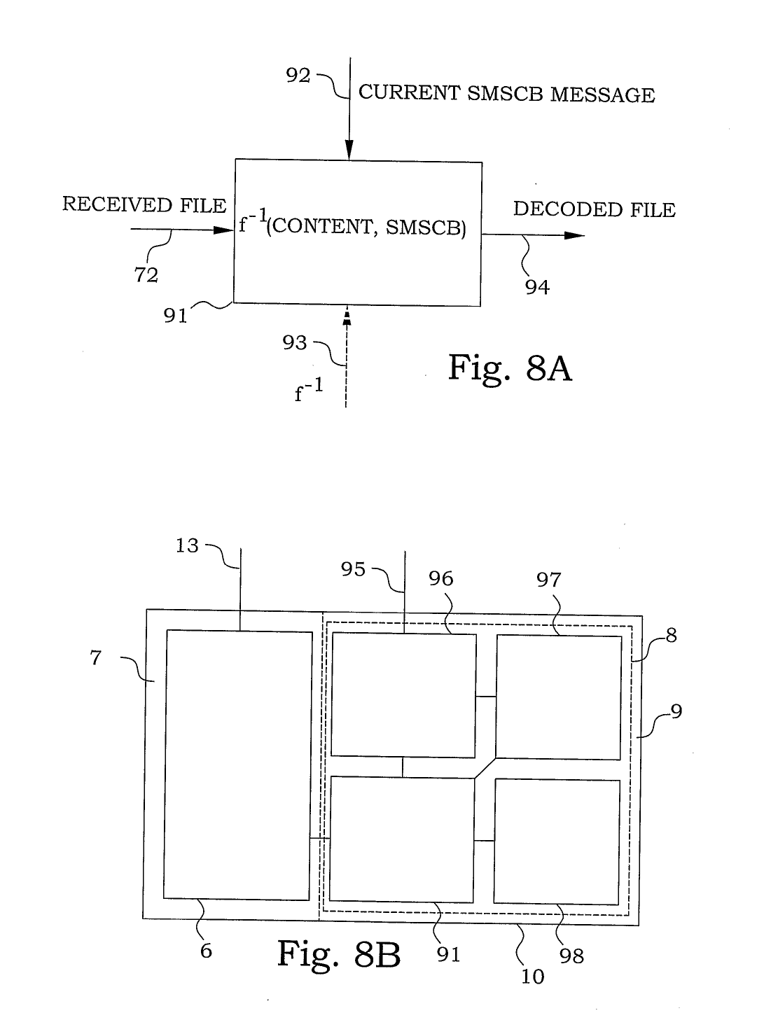

FIG. 8A illustrates an embodiment of the principles for authentication in a user terminal connected to a cellular communications network according to the present invention. A secure data file 72 is provided to a decoder 91. Data 92, comprising a symbol sequence, related to at least a part of a presently received broadcast message is provided to the decoder 91. The decoder 91 is arranged to provide an output decoded data entity 94, being a pre-determined function of the received file content 72 and the symbol sequence 92, that is an inverse function compared to the one used for encoding the data. In the embodiment of FIG. 8A, a GSM cellular system is assumed, thereby using the SMSCB messages.

In other words, the encoded file is sent to the users mobile phone. In the phone, a media player or execution environment reads the message sent on the SMSCB channel, and decodes the encoded file using this. If the received SMSCB message, or at least the parts used for encoding, differs from the SMSCB message used when encoding the media, the decoding will fail. The encoding can also be performed in such a way that more than one SMSCB message can be used for opening the encoded file.

The encoders do not necessary use the entire SMSCB message as it is. It can provide the necessary symbol sequence as encrypted variants of the message, perhaps also including other information, such as user unique ID. It can also use only selected parts of the message.

In particular embodiments, e.g. where the secure encoded data file is provided through broadcast signalling of any kind, additional security may be obtained if the decoder 91 further need information 93 about the decoding function f⁻¹ itself. This is indicated by the dashed arrow in FIG. 8A. The decoding function information 93 can e.g. be provided in advance using any dedicated transfer techniques. When the actual secure data entity is broadcast, the authorized user must have access to the decoding function information as well as the present broadcast control message. For instance, several options for decoding functions may be provided initially, and a header for the media stream can define which function and/or which part of the broadcast message that should be used for that media stream. In such a way, a message that is essentially plain text or a normal greeting text can be used by instead adjusting the encryption function.

The solution has some aspects in common with cable television services with a receiver box and a subscriber card. In such cable TV systems, the broadcast content is encoded with a unique code. In the decoder box, the subscriber puts a card with one or several codes used to decode the broadcast signal. Hence, the encoding-decoding procedure is similar. The difference here is that the code used to decode the media, is at least partly broadcast on a control channel. This makes it possible to have a content or application protecting system without distributing codes on cards. It is also possible to have a geographical dimension, and one can allow the user to store the encoded content/application and even share it with his or her friends, e.g. with memory cards, Bluetooth, IR or a P2P network, and still have full control over how, when and where and by whom, it can be used.

A block scheme of an embodiment of a device receiving and decoding secure data entities according to the present invention is illustrated in FIG. 8B. The device is typically a user terminal 10. A broadcast control message receiver 6 in a control plane portion 7 of the user terminal 10 receives continuously broadcast control messages 13, and is therefore always updated about the presently broadcast message. A secure data entity 95 is received by a receiver 96 of a decoder unit 8 in the user plane 9 of the user terminal 10. In the present embodiment, the decoder unit 8 also comprises a data storage 97 connected to the receiver. The secure data entity can thereby be stored in the data storage 97 and retrieved at a later occasion. A decoder 91 is connected to the receiver 96 and the data storage 97 to be able to receive a secure data entity from either unit. The decoder 91 is also connected to the broadcast control message receiver 6 of the control plane 7 to retrieve the presently valid broadcast message. The broadcast control message receiver 6 creates a symbol sequence from the presently valid broadcast message and provide it to the decoder 91. The decoder 91 is arranged for accessing the secure digital entity proving authorization. To this end, the decoder 91 then uses at least a part of the provided symbol sequence during decoding of the secure data entity. The decoded data entity is finally provided to an application section 98, where the content of the data entity can be utilized. The application section 98 can e.g. be a processor, where application software extracted from the secure data entity can be run. The application section 98 may e.g. also be a media player, presenting an audio or video presentation corresponding to the data content.

Control plane routines in a mobile terminal are very difficult to manipulate. In most cases, software is securely locked for unauthorized manipulation. The decoding part of the present invention is based on a symbol sequence obtained directly from a certain well-defined register in the control plane part of the mobile terminal. In this way, it is believed that manipulation of a device according to the present invention is prevented, at least to a certain degree. The user has no possibility to manipulate the register containing the broadcast message or any symbol sequence deduced therefrom. Even though the broadcast control message is publicly available for anyone connected to the cellular network, such information is anyway difficult to utilize for unauthorized use.

In GSM the SMSBC message consists of 88 octets segmented into four 22 octet blocks. The message header consists of six octets used to signal if the message is a new one or not. If the number is the same as the number of the already decoded message, the message is the same and the terminal will not decode the message again. If the number is a new one, it is a new message and the terminal will decode it. The majority of the remaining parts of the SMSBC message corresponds to the actual broadcast control message.

It is possible to construct a hierarchical structure of the SMSBC, which determines time duration and spatial position. This can be used to decide where and when the content of a secure data entity should be “decodeable” by the user. The examples below are shown for an intended use in GSM, but similar hierarchical structures can be constructed for any cellular communication systems having broadcast control messages.

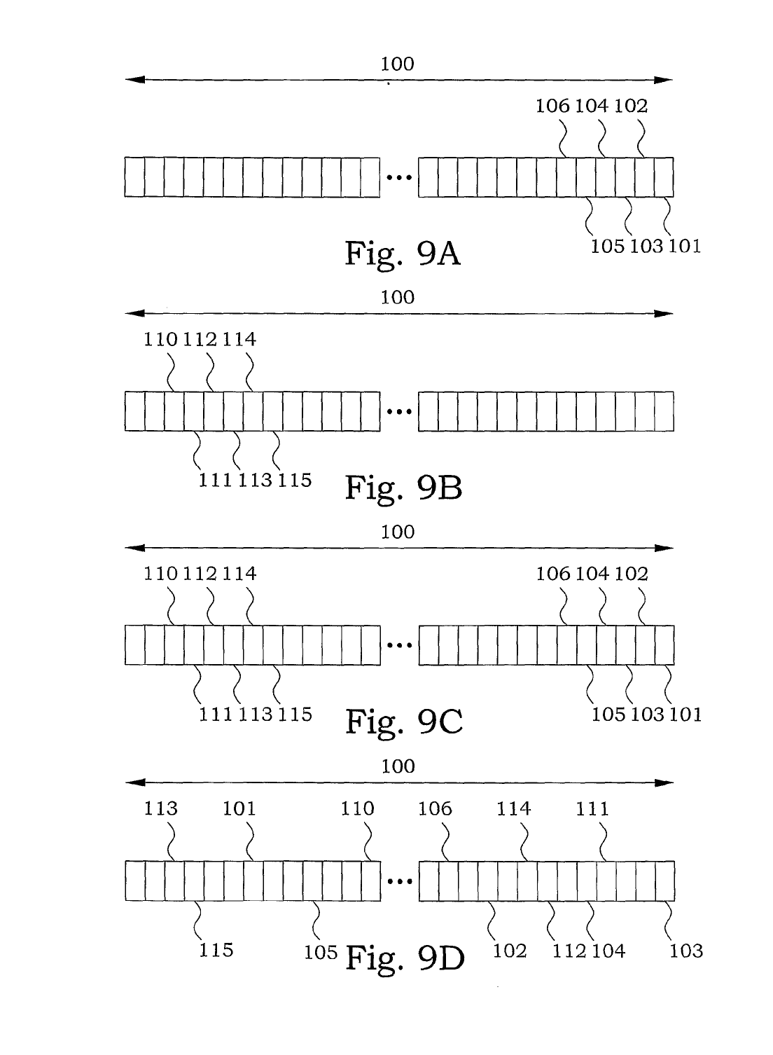

In a hierarchical SMSCB structure 100, the 66 octets in the message are varied in a scalable way, with reference to FIG. 9A. The octets can for instance be varied in time, providing a time reference of the accessibility. In an exemplifying embodiment according to FIG. 9A, the last octet 101 changes every month, the second last octet 102 changes every week, the third last octet 103 changes every day, the fourth last octet 104 changes every 6 hours, the fifth last octet 105 changes every hour and the sixth last octet 106 changes every ten minutes. By making the encoding/decoding dependent on predetermined ones of these octets, the validity of the encoding/decoding will obtain the corresponding time pattern.

In a similar way, as shown by FIG. 9B, the SMSCB octets 100 can be used to give the authorization a spatial limitation. A first octet 110 can be common to all broadcast control messages sent within the same country, a second octet 111 is common to all messages broadcast within a certain region, a third octet 112 is common to all messages broadcast within a certain town, a fourth octet 113 is common to all messages broadcast within a certain town district, a fifth octet 114 is common to all messages broadcast within a certain block, and a sixth octet 115 is unique for each cell. In this way it is possible to determine the spatial range in which a user is allowed to access the secure data entity.

In FIG. 9C, an embodiment is illustrated, where the SMSCB enables both a spatial and time restriction.

In FIG. 9D, another embodiment of a SMSCB structure having both spatial and time dependencies is illustrated. In this embodiment, the octets used for such limitations are spread in an irregular pattern over the SMSCB structure in order to make any analysis of such patterns more difficult.

Above, the time and spatial dependencies are restricted to one octet each. One may realize that such dependencies may be built by smaller and/or larger building blocks, comprising e.g. parts of octets or a multitude of octets.

As indicated further above, a certain service may use certain parts of the 88 octets. In such a way, a broadcast message may serve as key to different services at the same time. More than one set of structures according to the FIGS. 9A-D can thus be present in different configurations in one and the same broadcast message.

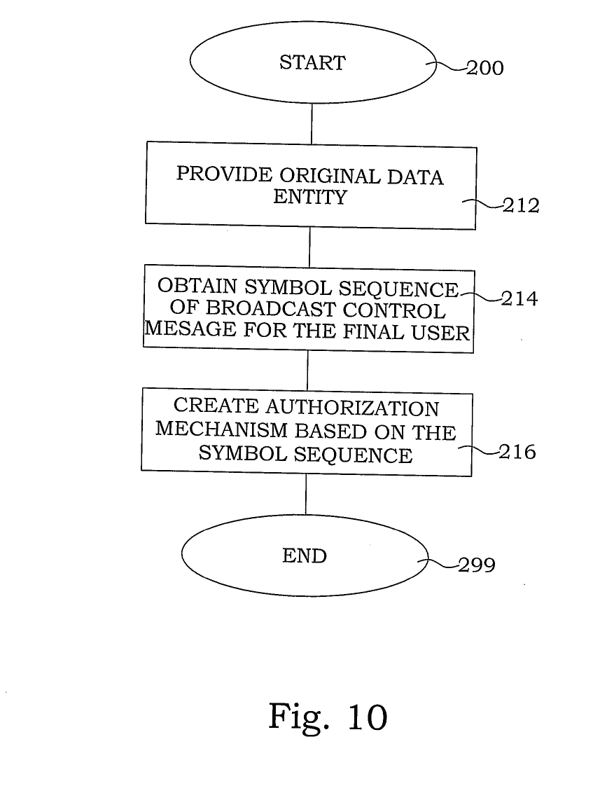

FIG. 10 illustrates a flow diagram of the main steps of an embodiment of a method for generating secure data according to the present invention. The procedure starts in step 200. In step 212, an original data entity is provided. A symbol sequence representing at least a part of a broadcast control message intended for the final user is obtained in step 214. This can in one embodiment be performed by signalling with a cellular network node. Step 216 comprises a creation of an authorization mechanism based on the symbol sequence. Typically, such authorization mechanism is an encoding of the data using the symbol sequence as input parameter. The procedure ends in step 299.

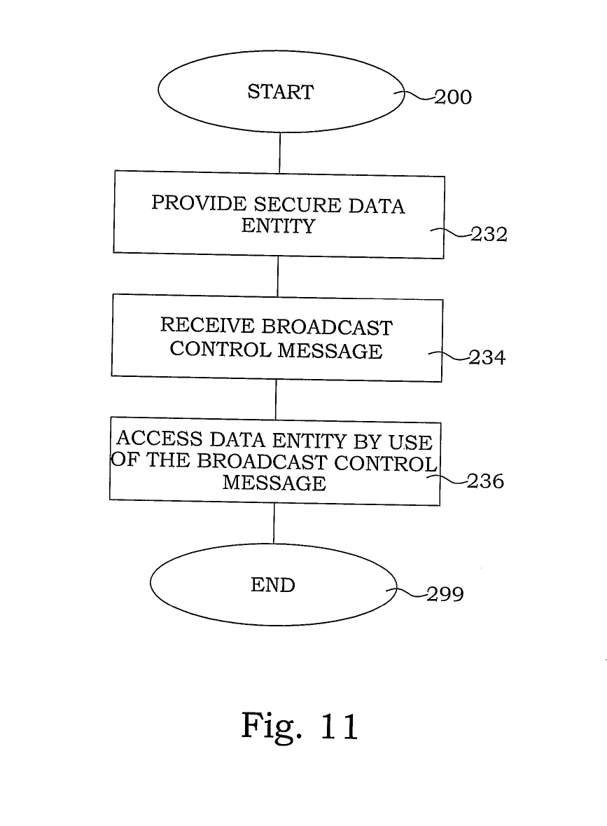

FIG. 11 illustrates a flow diagram of the main steps of an embodiment of a method for accessing secure data according to the present invention. The procedure starts in step 200. In step 232, a secure data entity according to the present invention is provided. A broadcast control message from a cellular communication network is received in step 234. Step 236 comprises an access of the secure data entity based on at least a part, e.g. a certain symbol sequence, representing the broadcast control message. Typically, such access mechanism is a decoding of the secure data using the broadcast control message as input parameter. The procedure ends in step 299.

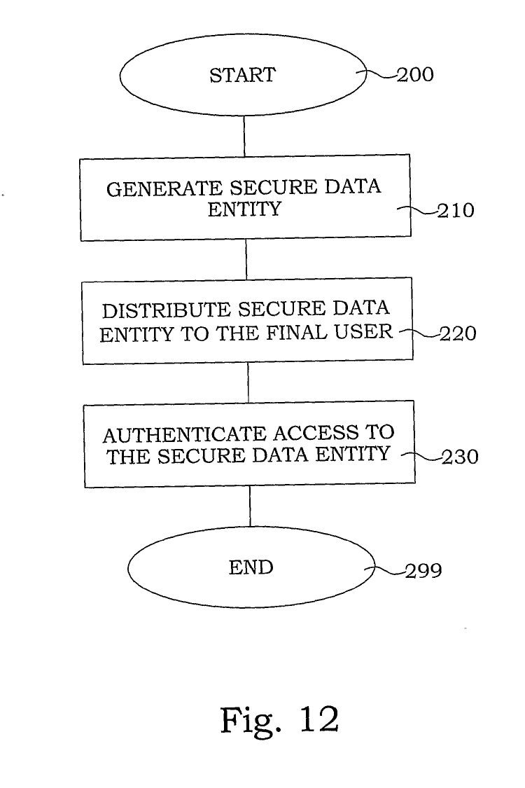

FIG. 12 illustrates a flow diagram of the main steps of an embodiment of a general method for distributing secure data according to the present invention. The procedure starts in step 200. In step 210, a secure data entity is generated, preferably according to the embodiment illustrated in FIG. 10. In step 220, the secure data entity is distributed to the final user. Such a distribution can be of any kind; through the cellular communications system providing the broadcast control message, through other wireless communications system, including broadcast systems or through wire or fibre connections. Finally, in step 230, access to the secure data entity is authenticated, preferably according to the embodiment illustrated in FIG. 11. The procedure ends in step 299.

The present invention presents a solution to add a media an/or application lock based on existing 3GPP radio network standards, making it possible to restrict media content and applications where and when to be used based at least on the users position, and/or time. Once the data is transferred to the final user, the invention operates without any additional signalling at the occasion when the application or data content is to be used. Hence, the lock works perfectly on mobile phones also in idle mode. There is no need to go to dedicated mode for signalling with authorization servers in the network. Instead of application layer signalling between terminal clients and content servers, the control layer features of the mobile network is used as a secure channel for enabling or disabling of media and applications.

It can be used in applications such as video and audio distribution on certain locations and during certain times and it can be used to disable applications when the user is not at the location it is supposed to be used or during a time when it shall be used. It can also be used for creating tickets or coupons (e.g. Bluetooth, IR, RFID or “display barcode”) and make them work on particular locations, again without signalling with the network. It can also without extra signalling be used to make an already downloaded file only executable or playable in a phone with a particular operator subscription in it. This means that files downloaded when having an operator A subscription will not be usable if the user change the subscription to operator B.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. A method for generating secure data entities for use in a device connected to a cellular communications network, comprising the steps of:
providing an original data entity;
obtaining symbol sequence corresponding to a broadcast control message to be used in the cellular communications network; and
creating an authorization mechanism for the original data entity based on the symbol sequence.

2. The method according to claim 1, wherein the step of obtaining the symbol sequence comprises the steps of:
receiving the symbol sequence regularly from the cellular communications network.

3. The method according to claim 1, wherein the step of obtaining the symbol sequence comprises the steps of:
sending a request to the cellular communications network for a suitable symbol sequence; and
receiving the symbol sequence from the cellular communications network.

4. The method according to claim 3, wherein the request comprises at least one of: an intended validity time; and an intended validity spatial region.

5. The method according to claim 1, wherein the step of creating an authorization mechanism comprises encrypting of at least a part of the original data entity in such a way that the broadcast control message can be used for decrypting.

6. A method for authentication, comprising the steps:
providing a secure digital entity associated with an authorization demand;
receiving, in a user terminal connected to a cellular communications network, a broadcast control message from the cellular communications network; and
accessing the secure digital entity proving authorization by use of at least a part of the received broadcast control message.

7. The method according to claim 6, wherein the step of accessing the secure digital entity in turn comprises the steps:
creating an authorization key based on at least a part of the received broadcast control message; and
application of the authorization key for accessing the secure digital entity.

8. The method according to claim 7, wherein the a authorization key is based also on an identity associated with the user terminal.

9. The method according to claim 6, wherein the step of accessing the secure digital entity comprises decrypting at least a part of the secure digital entity using the at least a part of the received broadcast control message.

10. The method according to claim 6, wherein the step of providing a secure digital entity in turn comprises receiving the secure digital entity over the cellular communications network.

11. The method according to claim 6, wherein the step of providing a secure digital entity in turn comprises receiving the secure digital entity over a communications system different from said cellular communications system.

12. The method according to claim 6, wherein the step of providing a secure digital entity in turn comprises retrieving the secure digital entity from a data storage.

13. The method according to claim 6, wherein the step of providing is performed in a device separate from but connected to said user terminal;
said method comprising the further step of providing information related to the received broadcast control message to said device;
whereby said step of accessing being performed in said device.

14. A method for distributing secure data entities in a cellular communications network, comprising the steps of:
generating secure data entity comprising the steps of:
providing an original data entity;
obtaining symbol sequence corresponding to a broadcast control message to be used in the cellular communications network; and
creating an authorization mechanism for the original data entity based on the symbol sequence;
distributing the generated secure data entity to an access device; and
authenticating access to the secure data entity in the access device.

15. The method according to claim 14, wherein the step of distributing the generated secure data entity to a user terminal comprises transmitting of the generated secure data entity over the cellular communications network.

16. The method according to claim 14, wherein the step of distributing the generated secure data entity to a user terminal comprises transmitting of the generated secure data entity over a broadcast signaling system.

17. The method according to claim 14, wherein the step of distributing the generated secure data entity to a user terminal comprises transmitting of the generated secure data entity over a communications system different from said cellular communications network.

18. The method according to claim 14, further comprising: transmitting a request for the secure data entity from the user terminal to a node for generating secure data entities.

19. The method according to claim 14, wherein the broadcast control message is independent of which mobile terminals are present in different cells of the cellular communication network.

20. A service provider node, comprising:
means for providing an original data entity;
means for obtaining symbol sequence corresponding to a broadcast control message that is going to be used in a cellular communications network; and
means for creating an authorization mechanism for the original data entity based on the symbol sequence.

21. The service provider node according to claim 20, wherein the means for obtaining the symbol sequence in turn comprises communication means arranged for sending a request to the cellular communications network for a suitable symbol sequence, and for receiving the symbol sequence from the cellular communications network.

22. The service provider node according to claim 21, wherein the request comprises at least one of:
an intended validity time; and
an intended validity spatial region.

23. The service provider node according to claim 20, wherein the means for creating an authorization mechanism comprises encryption means arranged for encrypting at least a part of the original data entity in such a way that the broadcast control message can be used for decrypting.

24. A user terminal coupled with a cellular communications network, comprising:
means for providing a secure digital entity associated with an authorization demand;
receiver for receiving a broadcast control message from the cellular communications network; and
means for accessing the secure digital entity proving authorization by use of at least a part of the received broadcast control message.

25. The user terminal according to claim 24. wherein the means for accessing the secure digital entity in turn comprises:
means for creating an authorization key based on at least a part of the received broadcast control message; and
means for applying the authorization key for accessing the secure digital entity.

26. The user terminal according to claim 25, wherein the authorization key is based also on an identity associated with the user terminal.

27. The user terminal according to claim 24, wherein the means for accessing the secure digital entity comprises decryption means arranged for decrypting at least a part of the secure digital entity using the at least a part of the received broadcast control message.

28. The user terminal according to claim 24, wherein the means for providing a secure digital entity in turn comprises a receiver of the secure digital entity over the cellular communications network.

29. The user terminal according to claim 24, wherein the means for providing a secure digital entity in turn comprises a receiver of the secure digital entity over a broadcast signaling system.

30. The user terminal according to claim 24, wherein the means for providing a secure digital entity in turn comprises a receiver of the secure digital entity over a communications system different from said cellular communications network.

31. The user terminal according to claim 24, wherein the means for providing a secure digital entity in turn comprises means for retrieving the secure digital entity from a data storage.

32. The user terminal according to claim 31, wherein the data storage is an external data storage.

33. A cellular communications system, comprising:
a node comprising:
means for providing an original data entity;
means for obtaining symbol sequence corresponding to a broadcast control message that is going to be used in a cellular communications network; and
means for creating an authorization mechanism for the original data entity based on the symbol sequence; and
means for distributing the generated secure data entity over the cellular communications network to a user terminal according to claim 24.

34. The cellular communications system according to claim 33, further comprising:
means for transmitting a request for the secure data entity from the user terminal over the cellular communications network to a node for generating secure data entities.

35. The cellular communications system, according to claim 33, wherein the broadcast control message is independent of which mobile terminals are present in different cells of the cellular communication network.

36. The user terminal according to claim 24, wherein the broadcast control message is independent of which mobile terminals are present in different cells of the cellular communication network.

37. The service provider node according to claim 20 wherein the broadcast control message is independent of which mobile terminals are present in different cells of the cellular communication network.
